(19) United States
(12) Patent Application Publication
(10) Pub. No.: US 2026/0277440 A1
(43) Pub. Date: Sep. 17, 2026

(54) MEMORY SYSTEM AND INFORMATION PROCESSING SYSTEM

(71) Applicant: Kioxia Corporation, Tokyo (JP)

(72) Inventors: Akiyuki KANEKO, Yokohama Kanagawa (JP); Hirotsugu KAJIHARA, Yokohama Kanagawa (JP); Yukimasa MIYAMOTO, Yokohama Kanagawa (JP); Daisuke TAKI, Yokohama Kanagawa (JP)

(21) Appl. No.: 19/324,889

(22) Filed: Sep. 10, 2025

(30) Foreign Application Priority Data
Mar. 14, 2025 (JP) 2025-041486

(51) Int. Cl. G06F 3/06

(52) U.S. Cl. CPC G06F 3/0611; G06F 3/0659; G06F 3/0683

(57) ABSTRACT

A memory system includes a first storage device, a second storage device that operates at a lower processing speed than the first storage device, and a controller. The controller is communicable with a host and configured to set an access of a predetermined pattern from the host as an indication from the host regarding data transfer between the first storage device and the second storage device. The access of the predetermined pattern comprises writing of pattern data having a predetermined length and a predetermined bit sequence. The controller is further configured to, in response to a command, from the host, requesting the access of the predetermined pattern at an address in the first storage address or the second storage address, perform a data transfer operation to transfer data stored at the address between the first storage device and the second storage device.

### CROSS-REFERENCE TO RELATED APPLICATIONS

This application is based upon and claims the benefit of priority from Japanese Patent Application No. 2025-041486, filed Mar. 14, 2025, the entire contents of which are incorporated herein by reference.

### FIELD

An embodiment described herein relates generally to a memory system and an information processing system.

### BACKGROUND

Recently, such cases that a large memory capacity is required have been increasing due to development of machine learning, artificial intelligence (AI), and the like. According to such a situation, a storage class memory (SCM) which is inexpensive and the capacity of which is expandable, though the speed of which is lower than a dynamic random access memory (DRAM) has been employed.

As an interface standard for the SCM, Compute Express Link (CXL) is known. Furthermore, in order to increase performance while reducing costs in a memory system using CXL, there is a method of using a combination of a plurality of memories with different performances (tiers).

For example, frequently accessed data (hot data), which is ranked at a fast tier, is stored in a DRAM with a high speed but with a small capacity, and infrequently accessed data (cold data), which is ranked at a slow tier, is stored in an SCM (low-latency NAND flash memory)with a low speed but with a large capacity.

In such a configuration, it is important how each piece of data is ranked in the fast tier or the slow tier and how data is moved between different storages for the tiers.

### BRIEF DESCRIPTION OF THE DRAWINGS

FIG. 1 is a diagram showing a configuration example of a memory system according to an embodiment.

FIG. 2 is a diagram illustrating a comparative example for the memory system according to the embodiment.

FIGS. 3A-3D are diagrams illustrating an example of a procedure for data movement between tiers in the memory system according to the embodiment.

FIG. 4 is a flowchart showing a flow of operation of promotion in the memory system according to the embodiment.

FIG. 5 is a flowchart showing a flow of operation of demotion in the memory system according to the embodiment.

FIG. 6 is a flowchart showing a flow of operation at the time when an application program operating in a host connected to the memory system according to the embodiment starts.

FIG. 7 is a flowchart showing a flow of operation of the application program operating in the host connected to the memory system according to the embodiment, related to the promotion.

FIG. 8 is a flowchart showing a flow of operation of the application program operating in the host, related to the promotion when the memory system according to the embodiment is set not to perform writing of pattern data.

### DETAILED DESCRIPTION

An embodiment of the present invention provides a memory system capable of efficiently performing arrangement of data in each tier and movement of data between tiers, and an information processing system.

In general, according to an embodiment, a memory system includes a first storage device, a second storage device that operates at a lower processing speed than the first storage device, and a controller. The controller is communicable with a host and configured to set an access of a predetermined pattern from the host as an indication from the host regarding data transfer between the first storage device and the second storage device. The access of the predetermined pattern comprises writing of pattern data having a predetermined length and a predetermined bit sequence. The controller is further configured to, in response to a command, from the host, requesting the access of the predetermined pattern at an address in the first storage address or the second storage address, perform a data transfer operation to transfer data stored at the address between the first storage device and the second storage device.

An embodiment will be described below with reference to drawings.

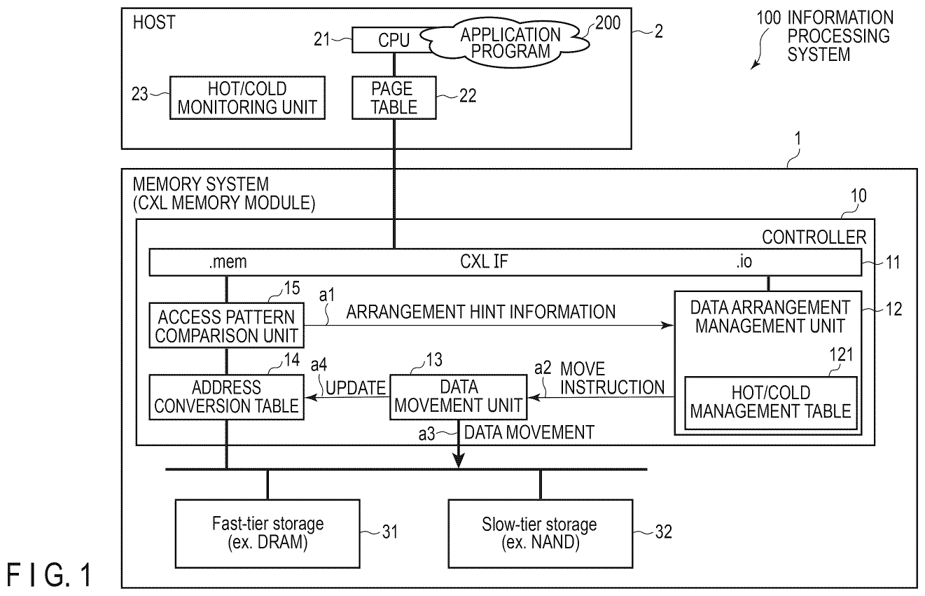

FIG. 1 is a diagram showing a configuration example of a memory system 1 according to an embodiment. FIG. 1 also shows an example of configuring an information processing system 100 by connecting the memory system 1 and a host 2. The host 2 is an information processing apparatus like a server or a personal computer.

The memory system 1 includes a controller 10, a high-speed but small-capacity fast-tier storage 31 which is, for example, a DRAM, and a low-speed but large-capacity slow-tier storage 32 which is, for example, a NAND flash memory.

The controller 10 controls the fast-tier storage 31 and the slow-tier storage 32. Specifically, in response to a request of the host 2, the controller 10 controls a process for writing data to the fast-tier storage 31 or the slow-tier storage 32 or controls a process for reading data from the fast-tier storage 31 or the slow-tier storage 32.

The controller 10 includes a CXL interface (CXL IF) 11, a data arrangement management unit 12, a data movement unit 13, an address conversion table 14, and an access pattern comparison unit 15. The data arrangement management unit 12, the data movement unit 13, and the access pattern comparison unit 15 may be configured by a CPU included in the memory system 1 executing a program or may be configured as hardware like electrical circuits.

The CXL interface 11 supports three kinds of protocols, CXL.io, CXL.cache, and CXL.mem, which are defined by the CXL, and controls communication with the host 2 with each of the protocols. That is, the memory system 1 is a CXL memory module. The CXL is an interface standard that enables load/store access from the CPU of a host to a CXL memory module similarly to load/store access to a main memory.

CXL.io is a protocol that provides functions compatible with PCIe™ (PCI Express™). CXL.io is used, for example, for communication for a host to perform initialization of a CXL memory module or various kinds of settings.

CXL.cache is a protocol used for communication for exchanging data between the cache of the CPU of a host and a CXL memory module while maintaining cache coherency.

CXL.mem is a protocol used for communication for the CPU of a host to perform reading/writing (load/store) from/to the memory of a CXL memory module. In CXL.mem, a host physical address is used as an address for a host CPU to read from or write to a CXL memory module. Hereinafter, the address will be referred to as a CXL address.

The data arrangement management unit 12 manages arrangement of data in the fast-tier storage 31 and the slow-tier storage 32. The data arrangement management unit 12 includes a hot/cold management table 121. The hot/cold management table 121 holds information for judging, for each piece of data stored in the fast-tier storage 31 and data stored in the slow-tier storage 32, whether the data is hot data or cold data. As described before, the hot data is frequently accessed data, and the cold data is infrequently accessed data. Hereinafter, the hot data may be also referred to simply as hot, and the cold data may be also referred to simply as cold.

The hot data should be stored in the fast-tier storage 31, and the cold data should be stored in the slow-tier storage 32. Therefore, for example, when data stored in the slow-tier storage 32 changes from cold to hot, it becomes necessary to cause the data to move from the slow-tier storage 32 to the fast-tier storage 31. On the contrary, for example, when data stored in the fast-tier 31 changes from hot to cold, it becomes necessary to cause the data to move from the fast-tier storage 31 to the slow-tier storage 32. To cause data to move from the slow-tier storage 32 to the fast-tier storage 31 is referred to as promotion or the like. Furthermore, to cause data to move from the fast-tier storage 31 to the slow-tier storage 32 is referred to as demotion or the like. The data arrangement management unit 12 notifies the data movement unit 13 of a move instruction (a2) to move data between the fast-tier storage 31 and the slow-tier storage 32, based on arrangement hint information (a1) from the access pattern comparison unit 15 to be described below.

Based on the move instruction (a2) from the data arrangement management unit 12, the data movement unit 13 causes data in the fast-tier storage 31 to move to the slow-tier storage 32 or causes data in the slow-tier storage 32 to move to the fast-tier storage 31 (a3). When having moved data between the fast-tier storage 31 and the slow-tier storage 32, the data movement unit 13 updates the address conversion table 14 (a4).

The address conversion table 14 holds a correspondence relationship between an address (a CXL address) specified by the host 2 and an address (a physical address) indicating a location in the fast-tier storage 31 or in the slow-tier storage 32.

The access pattern comparison unit 15 monitors memory access from the host 2 to the memory system 1 performed using the CXL.mem protocol. Specifically, the access pattern comparison unit 15 monitors commands transmitted to the memory system 1 by the host 2. When detecting memory access corresponding to a preset pattern, the access pattern comparison unit 15 judges that arrangement hint information has been transmitted from the host 2 and notifies the data arrangement management unit 12 of the arrangement hint information (a1). Presetting of the pattern of memory access has been performed in advance by the host 2 using the CXL.io protocol.

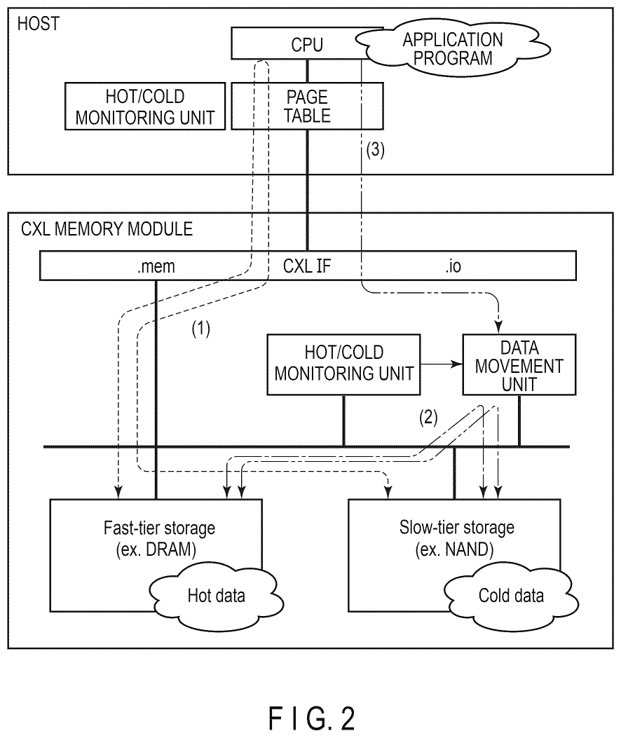

Here, a description will be made on a comparative example for the memory system 1 according to the present embodiment that acquires arrangement hint information from the host 2 by the access pattern comparison unit 15, with reference to FIG. 2.

A first comparative example is an example in which a host performs data movement ((1) a broken line).

In the first comparative example, the host manages a plurality of tiers individually. That is, the host recognizes the fast tier and the slow tier as separate areas.

The host recognizes whether each piece of data is hot or cold. The host can recognize whether each piece of data is hot or cold, for example, using an access flag bit of the page table of the operating system (OS). Or alternatively, an application program operating in the host can recognize, for data it accesses, whether the data is hot or cold because it can grasp the tendency of its access.

The host causes data to move between the tiers by reading cold data stored in the fast tier and writing the cold data to the slow tier (the data in the fast tier is invalidated) or reading hot data stored in the slow tier and writing the hot data to the fast tier (the data in the slow tier is invalidated).

Since both of the movement source and the movement destination of data are in a CXL memory module, the first comparative example is inefficient in that the host reads data from the CXL memory module once and writes the data to the CXL memory module.

A second comparative example is an example in which data movement is performed in the CXL memory module ((2) a dash-dotted line).

In the second comparative example, the CXL memory module has a hot/cold monitoring unit. The hot/cold monitoring unit of the CXL memory module has, for example, a counter with an arbitrary granularity (512 B [bytes], 4 KB, or the like) and monitors hot/cold by counting the number of accesses during a predetermined period. Transparently from the host, the CXL memory module internally executes data movement between the fast tier and the slow tier based on a result of the monitoring.

In the second comparative example, the distinction between the fast tier and the slow tier is not directly recognized from the host, and the fast tier and the slow tier are recognized as a memory with a total capacity of the fast tier and the slow tier.

In the second comparative example, if the CXL memory module has a large capacity, hot/cold monitoring resources increase. For example, in the case of counting the number of accesses using an 8-bit counter with a granularity of 4 KB, for a capacity of 1 TB, a 256-MB memory area is required.

In the CXL standard, CXL Hotness Monitoring Unit (CHMU) is defined as means for realizing hot/cold monitoring. In the CHMU, it is not necessary to have counters for all areas, and it is possible to reduce counter resources. However, when a collision occurs on a target counter, the counter value of the counter is discarded because limited counters are shared by a hash function and the like. Therefore, the risk of misjudgment of hot/cold is high.

A third comparative example is an example in which the host gives a hint to the CXL memory module ((3) a dot-dot-dash line).

The third comparative example is on the assumption of a combination of the first comparative example and the second comparative example. Specifically, the host recognizes whether each piece of data is hot/cold similarly to the first comparative example, and the CXL memory module internally performs data movement, transparently from the host, similarly to the second comparative example.

Under the assumption, the host gives a hint to the CXL memory module, and the CXL memory module internally performs data movement in the third comparative example. The hint is, for example, an instruction to move data at an address AAA from the fast tier to the slow tier.

Thereby, in the third comparative example, it is possible to reduce hot/cold monitoring resources in the CXL memory module.

In the third comparative example, overhead of conversion from a virtual address to a CXL address and of transmission of a hint via a sideband path (a path other than a CXL.mem path used for memory access) increases.

It is virtual addresses that an application program operating in the host handles. Meanwhile, an address specified by memory access from the host to the CXL memory module is a CXL address. In general, it is a virtual address that an application program can know, and an access flag bit of the page table of the OS is associated with a virtual address.

Therefore, it is necessary for the host side to refer to the page table to change a virtual address to a physical address (here, synonymous to a CXL address) on the host and then issue a move instruction specifying the CXL address, to the CXL memory using a sideband path. Though CXL.mem used for memory access is a protocol optimized for low latency, it has only a read/write function to read from and write to a memory and cannot transmit a command of a data move instruction or the like. Though a command can be transmitted with CXL.io, the overhead of CXL.io is larger in comparison with CXL.mem. Though the sideband path is not limited to a CXL.io path, the CXL does not have a method capable of accessing the CXL memory module with a low overhead like that of CXL.mem.

Returning to FIG. 1 in consideration of the above comparative examples, the description of the configuration example of the memory system 1 according to the present embodiment capable of efficiently performing data arrangement in each tier and data movement between the tiers will be continued.

As described before, the access pattern comparison unit 15 monitors commands the host 2 transmits to the memory system 1 using the CXL.mem protocol and detects memory access corresponding to a preset pattern. The host 2 presets a memory access pattern using the CXL.io protocol in advance.

The memory access pattern preset by the host 2 is a write command with a feature that does not occur in a common application program. For example, when the data write size suitable for the fast-tier storage 31 and the slow-tier storage 32 is 64 B, the host 2 generally transmits a write command requesting writing of 64 B write data to the memory system 1. In comparison, for example, in the case of 8 B partial write, the host 2 presets a memory access pattern, using arrangement hint information recommending the fast-tier storage 31 if data is “0x6A79C8F0453E2B40” (hereinafter referred to as pattern data 1) and using arrangement hint information recommending the slow-tier storage 32 if data is “0x6A79C8F0453E2B41” (hereinafter referred to as pattern data 2). Note that 0x at the top of the data indicates that the data is in hexadecimal notation. Sixteen alphanumeric characters (0 to 9 and A to F) after 0x indicate 4 bit values, respectively, and the alphanumeric characters indicate an 8 B value as a whole (4 bit×16=64 bit=8 B). That is, in this example, the following are preset:
(1) a write command requesting 8B partial write+memory access in which write data corresponds to the pattern data 1 (hereinafter referred to as an access pattern 1): memory access (dummy write) for giving arrangement hint information recommending the fast-tier storage 31; and
(2) a write command requesting 8 B partial write+memory access in which write data corresponds to the pattern data 2 (hereinafter referred to an access pattern 2): memory access (dummy write) for giving arrangement hint information recommending the slow-tier storage 32.

The host 2 in the present embodiment includes a hot/cold monitoring unit 23 to recognize whether each piece of data stored in the memory system 1 is hot or cold. The hot/cold monitoring unit 23 recognizes whether each piece of data is hot or cold, for example, using an access flag bit of a page table 22 of the OS (not shown). Or alternatively, since an application program 200 executed by a CPU 21 in the host 2 can grasp its tendency of access, it can recognize whether data it accesses is hot or cold. The application program 200 may recognize whether data it accesses is hot or cold in cooperation with the hot/cold monitoring unit 23 or may recognize whether data it accesses is hot or cold by grasping its tendency of access. The page table 22 holds correspondence relationships between virtual addresses and CXL addresses. The page table 22 is used to convert a virtual address to a CXL address. The page table 22 includes access flag bits indicating whether areas indicated by virtual addresses have been accessed or not, for example, during a predetermined period.

The application program 200 issues a write command of partial write corresponding to a preset pattern, to an area where data targeted by giving arrangement hint information is stored. This is dummy write that is naturally unnecessary for the application program 200 but is handled similarly to normal write to a memory using CXL.mem. That is, writing to a memory (the fast-tier storage 31 or the slow-tier storage 32) in the memory system 1 is actually performed. Therefore, the application program 200 secures a storage area corresponding to pattern data to be written by the dummy write, in the memory system 1 or in the main memory of the host 2, and saves data to be overwritten with the pattern data by the dummy write into the storage area secured in the memory system 1 or in the main memory of the host 2.

The dummy write is performed directly to the virtual address space handled by the application program 200. Since the dummy write is the same as normal write to a memory, conversion from a virtual address to a CXL address is performed in the host 2.

The dummy write is detected by the access pattern comparison unit 15, and the data arrangement management unit 12 is notified of a CXL address specified by the write command of the dummy write and write data, which is pattern data with a predetermined size, as arrangement hint information (a1). Based on the arrangement hint information (a1), the data arrangement management unit 12 instructs the data movement unit 13 to move data stored at the CXL address included in the arrangement hint information to a tier recommended by the pattern data.

There is a possibility that the data stored at the CXL address included in the arrangement hint information is already arranged in the tier recommended by the pattern data. If the CXL address included in the arrangement hint information indicates the inside of a tier different from the tier recommended by the pattern data, the data arrangement management unit 12 notifies the data movement unit 13 of an instruction to move the data stored at the location indicated by the CXL address between the tiers. The data movement unit 13 performs movement of the data between the tiers based on the instruction from the data arrangement management unit 12.

When receiving a response to the dummy write for giving the arrangement hint information to the memory system 1, from the memory system 1, the application program 200 restores the data targeted by the arrangement hint information, which has been overwritten with the pattern data by the dummy write, using the data saved in the memory system 1 or in the storage area secured in the main memory of the host 2. Specifically, issuance of a command for reading the restoration target data and issuance of a command for writing the restoration target data that has been read are performed.

Thus, the memory system 1 according to the present embodiment does not require resources for hot/cold management in the memory system 1, by the host 2 giving a hint of arrangement to the memory system 1.

Furthermore, since write using CXL.mem becomes a tier arrangement hint similarly to normal memory access, without using a sideband path such as a CXL.io path, it is possible to give the hint to the memory system 1 at a high speed and with a low overhead.

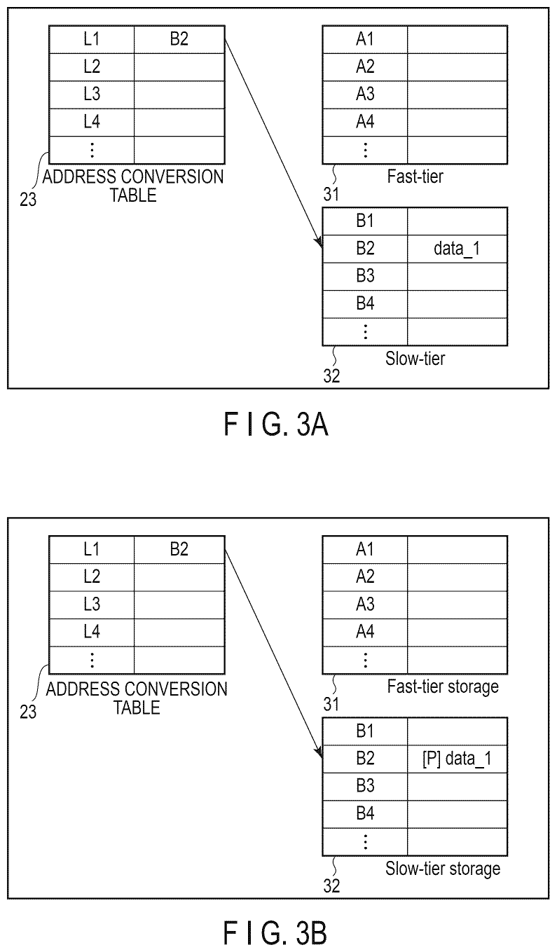

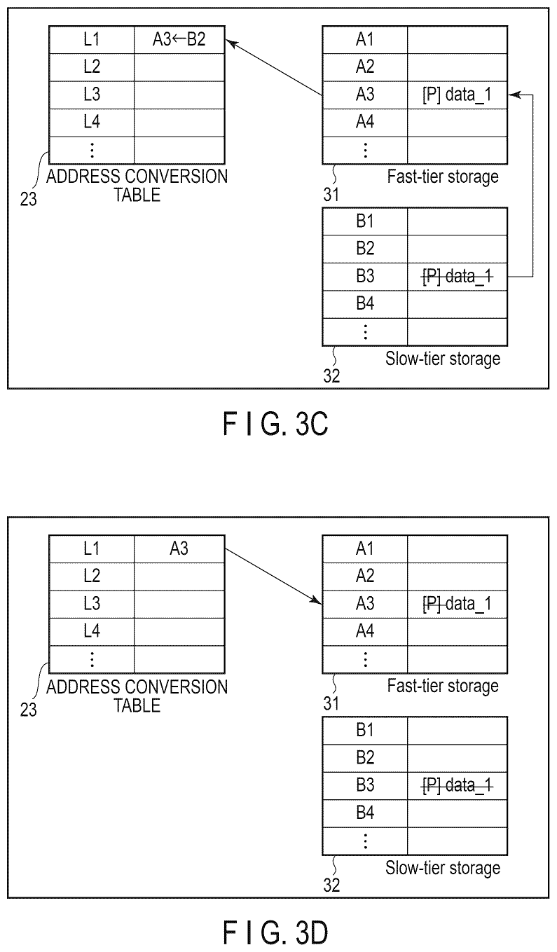

Here, a description will be made on an example of a procedure for data movement between the tiers in the memory system 1 according to the present embodiment, with reference to FIGS. 3A to 3D.

FIG. 3A shows a state of “data_1”, which is data stored at a CXL address “L1” in the CXL address space, being stored at a physical address “B2” in the slow-tier storage 32. The address conversion table 14 holds a correspondence relationship between the CXL address “L1” and the physical address “B2”.

Here, it is assumed that the data “data_1” has changed from cold to hot. That is, it is assumed that a situation has occurred in which the host 2 is to give a hint that the data “data_1” should be arranged in the fast-tier storage 31, to the memory system 1.

In this case, the host 2 transmits a write command to perform partial write of the pattern data 1, which is arrangement hint information recommending the fast-tier storage 31, at the CXL address “L1”, to the memory system 1. That is, the host 2 performs dummy write with the access pattern 1 for giving the arrangement hint information, using CXL.mem.

The memory system 1 that monitors commands from the host 2 by the access pattern comparison unit 15 recognizes that the write command is dummy write with the access pattern 1 for giving an arrangement hint. Meanwhile, in consideration of a case where the application program 200 of the host 2 has performed partial write of the pattern data 1 with some other intention, the memory system 1 actually executes partial write of the pattern data 1 requested by the host 2.

FIG. 3B shows a state in which partial write of the pattern data 1 to the physical address “B2” in the slow-tier storage 32 has been performed. In FIG. 3B, [P] indicates pattern data, [P]data_1 indicates that the top part of the data “data_1” has been overwritten with the pattern data.

In the case of performing dummy write for giving arrangement hint information, the host 2 performs a process for saving a part to be overwritten with pattern data as preprocessing for the purpose of restoring the part that has been overwritten with the pattern data later. For example, the host 2 temporarily secures an area with the size of the pattern data in the fast-tier storage 31 or in the main memory of the host 2 (hereinafter referred to as a temporary memory area) and executes data reading and data writing for saving the part to be overwritten with the pattern data.

Because the access pattern is the access pattern 1 for giving the arrangement hint information recommending the fast-tier storage 31, the memory system 1 confirms that the physical address “B2” specified by the write command is an address in the slow-tier storage 32 first. If the physical address “B2” is an address in the fast-tier storage 31, the memory system 1 skips the process for data movement between the tiers.

If the physical address “B2” is an address in the slow-tier storage 32, the memory system 1 causes the data at the physical address “B2” in the slow-tier storage 32 to move to the fast-tier storage 31. Accompanying the movement, the memory system 1 updates the address conversion table 14.

FIG. 3C shows a state in which the data “[P]data_1” at the physical address “B2” in the slow-tier storage 32 has moved to a physical address “A3” in the fast-tier storage 31, and the physical address “B2” associated with the CXL address “L1” has been updated to the physical address “A3” in the address conversion table 14.

In the case of having performed dummy write for giving arrangement hint information, the host 2 performs a process for writing back data that has been saved in a temporary memory area to a part that has been overwritten with pattern data as post-processing to restore the part that has been overwritten with the pattern data.

FIG. 3D shows a state in which the data at the physical address “A3” in the fast-tier storage 31 has transitioned from the data “data_1” the top part of which has been overwritten with the pattern data to the data “data_1” the top part of which has been restored.

After that, for example, it becomes possible for the application program 200 of the host 2 to read the data “data_1”, which is hot data, from the memory system 1 at a higher speed in comparison with the case of being stored in the slow-tier storage 32.

In dummy write for giving arrangement hint information, size information about an area to be moved may be included. For example, if pieces of size information corresponding to “L1” to “L4” are included in dummy write performed for the CXL address “L1”, physical addresses corresponding to “L1” to “L4” of the address conversion table 14 are acquired, and pieces of data at the physical addresses are sequentially moved.

Furthermore, when the application program 200 of the host 2 has performed partial write of the pattern data 1 with some other intention as described before, restoration of an overwritten part by preprocessing and post-processing for data that has been moved is not performed, unlike the case of dummy write with the access pattern 1 intended to data movement between the tiers. Therefore, the operation of the application program 200 using the pattern data 1 does not break down.

Similarly to the case of causing hot data to move from the slow-tier storage 32 to the fast-tier storage 31, which has been described with reference to FIGS. 3A to 3D, the host 2 can also give an instruction to cause cold data to move from the fast-tier storage 31 to the slow-tier storage 32 to the memory system 1 by performing dummy write with the access pattern 2. Practically, however, it is preferable to control movement of cold data from the fast-tier storage 31 to the slow-tier storage 32 in the memory system 1.

More particularly, though the host 2 can recognize whether each piece of data is hot or cold, the size of an area where cold data is to be stored is large, and there is normally a tendency that there are a lot of areas the number of accesses to which is 0 or significantly small. It costs much to select an appropriate movement target among the areas.

Furthermore, since the capacity of the fast-tier storage 31 for which a high-speed and high-cost memory (for example, a DRAM) is used is small, it is practical to manage the number of accesses only for the fast-tier storage 31 and recognize data close to cold among pieces of data arranged in the fast-tier storage 31.

From the above, the following are preferred:
(1) the host 2 detects data that has changed to hot and gives a hint that the data should be arranged in the fast-tier storage 31, to the memory system 1; (2) the memory system 1 performs movement of the target data from the slow-tier storage 32 to the fast-tier storage 31, based on the hint from the host 2; and (3) the free space of the fast-tier storage 31 decreases soon, and, at that time, the memory system 1 causes data close to cold, among pieces of data arranged in the fast-tier storage 31, to move to the slow-tier storage 32.

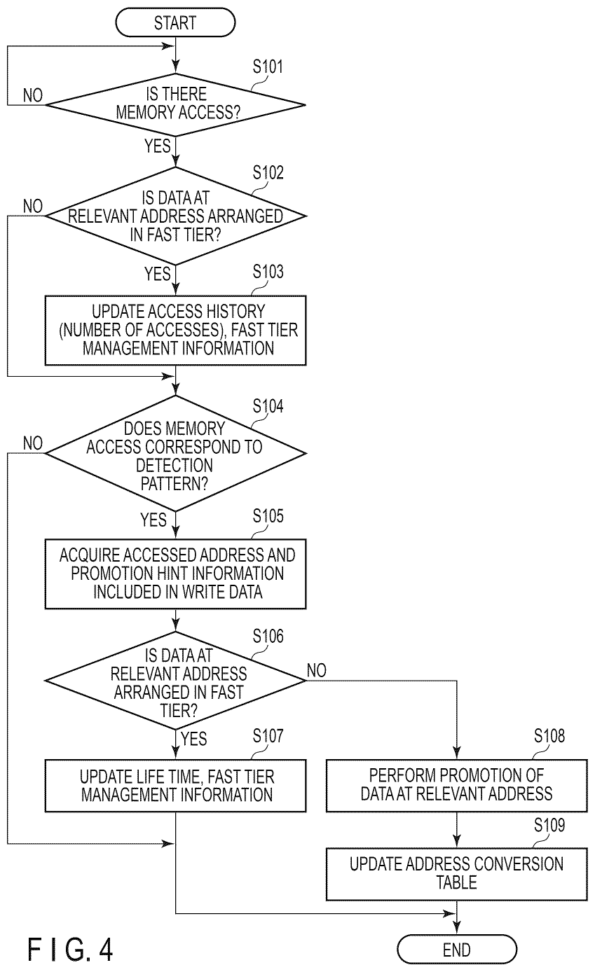

FIG. 4 is a flowchart showing a flow of operation of promotion in the memory system 1.

The memory system 1 monitors memory access from the host (S101). If there is no memory access (S101: NO), the memory system 1 continues monitoring of memory access from the host. If there is memory access (S101: YES), the memory system 1 judges whether data at a relevant address is arranged in the fast-tier storage 31 or not (S102). If the data is arranged in the fast tier storage 31 (S102: YES), the memory system 1 updates an access history (the number of accesses) which is management information about the fast-tier storage 31 (S103). The fast tier management information is information held in the hot/cold management table 121 of the data arrangement management unit 12. If the data is not arranged in the fast-tier storage 31 (S102: NO), the memory system 1 skips the process of S103.

Next, the memory system 1 judges whether the memory access from the host corresponds to a detection pattern or not (S104). Specifically, the memory system 1 judges whether the memory access corresponds to the access pattern 1 or access pattern 2 that has been preset. Note that, since movement of cold data from the fast-tier storage 31 to the slow-tier storage 32 is controlled in the memory system 1, the access pattern 2 actually does not appear.

If the memory access from the host does not correspond to any of the detection patterns (S104: NO), the memory system 1 ends the process for promotion. On the other hand, if the memory access corresponds to a detection pattern (S104: YES), the memory system 1 acquires the accessed address and promotion hint information included in write data (S105). Specifically, the memory system 1 recognizes that the promotion hint information is hint information to the effect that data at the relevant address should be arranged in the fast-tier storage 31.

Then, the memory system 1 judges whether the data at the relevant address is arranged in the fast-tier storage 31 or not (S106). If the data is arranged in the fast-tier storage 31 (S106: YES), the memory system 1 updates life time, which is fast tier management information (S107). The life time is information required for demotion described below and is, for example, information about remaining time during which the data can continue existing in the fast-tier storage 31. The update of the life time at S107 is, for example, to reset a timer that counts a predetermined time. When having updated the life time, the memory system 1 ends the process for promotion.

On the other hand, if the data at the relevant address is not arranged in the fast tier storage 31 (S106: NO), that is, if the data is arranged in the slow-tier storage 32, the memory system 1 performs promotion for causing the data at the relevant address to move from the slow-tier storage 32 to the fast-tier storage 31 (S108). Then, accompanying the movement, the memory system 1 updates the address conversion table 14 (S109).

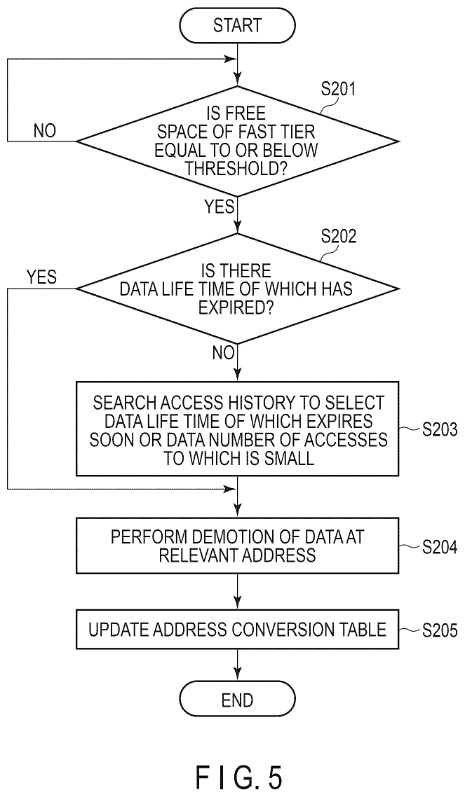

FIG. 5 is a flowchart showing a flow of operation of demotion in the memory system 1.

The memory system 1 monitors the free space of the fast-tier storage 31 (S201). If the free space of the fast-tier storage 31 exceeds a threshold (S201: NO), the memory system 1 continues monitoring of the free space of the fast-tier storage 31. If the free space of the fast-tier storage 31 is equal to or below the threshold (S201: YES), the memory system 1 judges whether or not there is data the life time of which has expired.

If there is not data the life time of which has expired (S202: YES), the memory system 1 searches the access history, which is the fast tier management information, to select data the life time of which expires soon or data the number of accesses to which is small, as a demotion target (S203). If there is data the life time of which has expired (S202: NO), the data becomes a demotion target, and, therefore, the memory system 1 skips the process of S203.

For data at a relevant address, that is, for the demotion target data, the memory system 1 performs demotion for causing the data to move from the fast-tier storage 31 to the slow-tier storage 32 (S204). Then, accompanying the movement, the memory system 1 updates the address conversion table 14 (S205).

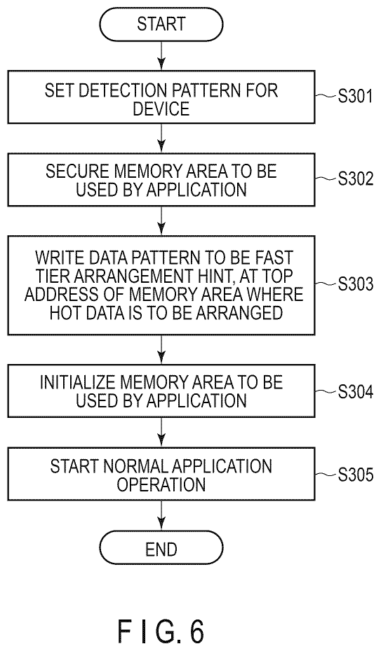

FIG. 6 is a flowchart showing a flow of operation at the time when the application program 200 operating in the host 2 starts.

The application program 200 sets a detection pattern, which is the access pattern 1 or the access pattern 2, for the memory system 1 (S301). Communication with the memory system 1 for the setting is performed with CXL.io.

Next, the application program 200 secures a memory area to be used by the application program 200 in the memory system 1 (S302). Next, the application program 200 writes data of a pattern to be a fast-tier storage 31 arrangement hint, at the top address of a memory area of data that is to be hot data (S303). By this process, an area in the fast-tier storage 31 can be associated with an area in the virtual memory space where hot data is to be written.

Next, the application program 200 initializes the memory area to be used by the application program 200, which has been secured at S302 (S304). After that, the application program 200 starts normal application operation (S305).

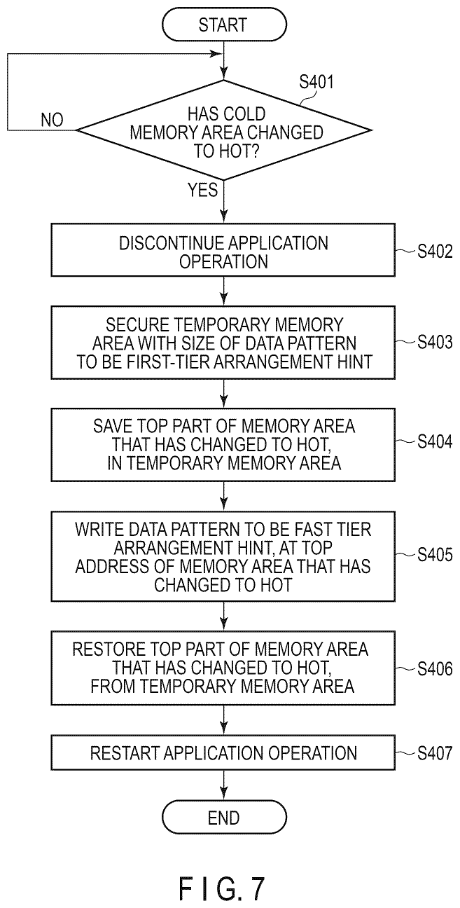

FIG. 7 is a flowchart showing a flow of operation of the application program 200 operating in the host 2, related to promotion.

The application program 200 monitors whether a cold memory area has not changed to hot (S401). If a memory area that has changed from cold to hot is not detected (S401: NO), the application program 200 continues monitoring of cold memory areas. If a memory area that has changed from cold to hot is detected (S401: YES), the memory system 1 suspends the application operation (S402).

The application program 200 secures a temporary memory area with the size of the data of the pattern to be the first-tier arrangement hint, in the memory system 1 (S403). Specifically, the application program 200 secures a temporary memory area with the size of the pattern data 1. The application program 200 stores the top part of the memory area that has changed to hot, in the temporary memory area secured at S403 (S404). That is, data of a part of the promotion target data, which is to be overwritten with the pattern data 1, is saved.

Next, the application program 200 writes the data of the pattern to be the fast-tier storage 31 arrangement hint, that is, the pattern data 1 at the top address of the memory area that has changed to hot (S405). Thereby, the promotion in the memory system 1 shown in FIG. 4 starts.

When receiving a response of the memory system 1 to the write at S405, the application program 200 restores the top part of the memory area that has changed to hot, with the data that has been saved in the temporary memory area (S406). After that, the application program 200 restarts the application operation discontinued at S402 (S407).

As described above, the memory system 1 according to the present embodiment can receive a tier arrangement hint from the host 2 via communication using CXL.mem. Thereby, it becomes possible for the host 2 to give a hint to the memory system 1 with a low overhead at a high speed.

That is, the memory system 1 according to the present embodiment can efficiently perform arrangement of data in each tier and movement of data between the tiers.

In the above description, for dummy write for giving an arrangement hint, writing of pattern data is actually executed. This is because of consideration of the case where the application program 200 of the host 2 has accessed the memory system 1 with a preset access pattern with some other intention.

Since the possibility that the access pattern 1 or the access pattern 2 appears with a different intention is extremely low, it is conceivable not to perform actual writing of the pattern data 1 or the pattern data 2, ignoring the possibility.

In this case, since the amount of writing to the fast-tier storage 31 or the slow-tier storage 32 decreases, the life (the endurance) of the memory system 1 can be extended. Furthermore, saving and restoration of data before and after data movement between the tiers becomes unnecessary.

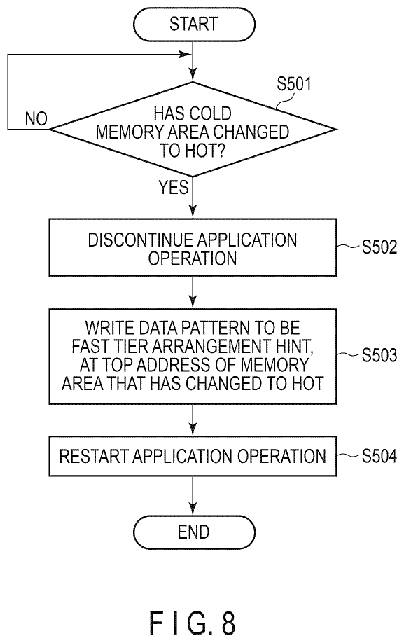

FIG. 8 is a flowchart showing a flow of operation of the application program 200 operating in the host 2, related to promotion when the memory system 1 is set not to perform writing of pattern data.

The application program 200 monitors whether a cold memory area has not changed to hot (S501). If a memory area that has changed from cold to hot is not detected (S501: NO), the application program 200 continues monitoring of cold memory areas. If a memory area that has changed from cold to hot is detected (S501: YES), the memory system 1 discontinues the application operation (S502).

The application program 200 writes the data of the pattern to be the fast-tier storage 31 arrangement hint, that is, the pattern data 1 at the top address of the memory area that has changed to hot (S503). After that, the application program 200 restarts the application operation discontinued at S502 (S504).

Thus, the flowchart in this case is the flowchart of FIG. 7 from which S403, S404, and S406 are removed. That is, the load on the application program 200 is reduced.

The memory system 1 in this case also makes it possible to efficiently perform data arrangement in each tier and data movement between the tiers.

In the above description, writing of the pattern data 1 or the pattern data 2, as a memory access pattern preset as arrangement hint information, by a write command with a feature that does not occur in a normal application program, for example, an 8 B partial write is given as an example. Writing of the arrangement hint information may be performed by 64 B write, 64 B being a data writing size suitable for the fast-tier storage 31 and the slow-tier storage 32. Furthermore, without being limited to a pattern of one piece of data, for example, a sequence of a plurality of pieces of data being written in particular order is also possible.

For example, writing by a write command that occurs in a normal application program but in a sequence with a feature that does not occur in a normal application program such as in order of data “0xAAA . . . ”, data “0xBBB . . . ”, and data “0xCCC . . . ” may be set as arrangement hint information. Thereby, it is possible to reduce the probability of occurrence of a case where an application accidentally issues a write command corresponding to arrangement hint information as meaningful data.

The types of storage devices used for the slow tier and the fast tier are not limited to DRAM or low-latency NAND flash memory. As an SCM assumed to be used as the slow tier, a PCM, a ReRAM, an MRAM, and the like can be additionally given.

The host interface is not limited to a CXL interface and may be any host interface through which the host can perform load/store access. For example, an NVDIMM to be fitted in a DIMM slot, or the like is also possible.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a first storage device;
a second storage device that operates at a lower processing speed than the first storage device; and
a controller communicable with a host and configured to:
set an access of a predetermined pattern from the host as an indication from the host regarding data transfer between the first storage device and the second storage device, the access of the predetermined pattern comprising writing of pattern data having a predetermined length and a predetermined bit sequence; and
in response to a command, from the host, requesting the access of the predetermined pattern at an address in the first storage address or the second storage address, perform a data transfer operation to transfer data stored at the address between the first storage device and the second storage device.

2. The memory system according to claim 1, wherein
the access of the predetermined pattern set by the controller comprises an access of a first predetermined pattern, which comprises wiring of first pattern data having the predetermined length and a first predetermined bit sequence, and
the controller is configured to perform, in response to a first command requesting the access of the first predetermined pattern at a first address in the first storage device, a first data transfer operation to transfer data stored at the first address in the first storage device to the second storage device.

3. The memory system according to claim 2, wherein
the access of the predetermined pattern set by the controller comprises an access of a second predetermined pattern, which comprises wiring of second pattern data having the predetermined length and a second predetermined bit sequence, and
the controller is configured to perform, in response to a second command requesting the access of the second predetermined pattern at a second address in the second storage device, a second data transfer operation to transfer data stored at the second address in the second storage device to the first storage device.

4. The memory system according to claim 1, wherein
the access of the predetermined pattern set by the controller comprises an access of a first predetermined pattern, which comprises wiring of first pattern data having the predetermined length and a first predetermined bit sequence, and
the controller is configured to perform, in response to a first command requesting the access of the first predetermined pattern at a first address in the second storage device, a first data transfer operation to transfer data stored at the first address in the second storage device to the first storage device.

5. The memory system according to claim 1, wherein the controller is configured to, during the data transfer operation, overwrite the pattern data onto a part of the data stored at the address and save the overwritten part of the data in a temporary memory.

6. The memory system according to claim 5, wherein the controller is configured to, during the data transfer operation, write the data stored at the address the part of which has been overwritten with the pattern data to a new address.

7. The memory system according to claim 6, wherein the controller is configured to, during the data transfer operation, replace the pattern data at the new address with the saved overwritten part of the data.

8. The memory system according to claim 1, wherein the controller is configured to receive the command in accordance with a first protocol for memory access.

9. The memory system according to claim 8, wherein
the controller is configured to set the access of the predetermined pattern as the indication regarding the data transfer between the first storage device and the second storage device, in response to a setup command from the host, and
the controller is configured to receive the setup command in accordance with a second protocol for input/output, the second protocol having a greater protocol overhead than the first protocol.

10. The memory system according to claim 9, wherein the first protocol is Compute Express Link (CXL).mem, and the second protocol is CXL.io.

11. An information processing system comprising:
a host; and
a memory system connected to the host, the memory system comprising:
a first storage device;
a second storage device that operates at a lower processing speed than the first storage device; and
a controller communicable with the host, wherein
the controller is configured to:
set an access of a predetermined pattern from the host as an indication from the host regarding data transfer between the first storage device and the second storage device, the access of the predetermined pattern comprising writing of pattern data having a predetermined length and a predetermined bit sequence; and
in response to a command, from the host, requesting the access of the predetermined pattern at an address in the first storage address or the second storage address, perform a data transfer operation to transfer data stored at the address between the first storage device and the second storage device.

12. The information processing system according to claim 11, wherein
the access of the predetermined pattern set by the controller comprises an access of a first predetermined pattern, which comprises wiring of first pattern data having the predetermined length and a first predetermined bit sequence, and
the controller is configured to perform, in response to a first command requesting the access of the first predetermined pattern at a first address in the first storage device, a first data transfer operation to transfer data stored at the first address in the first storage device to the second storage device.

13. The information processing system according to claim 12, wherein
the access of the predetermined pattern set by the controller comprises an access of a second predetermined pattern, which comprises wiring of second pattern data having the predetermined length and a second predetermined bit sequence, and
the controller is configured to perform, in response to a second command requesting the access of the second predetermined pattern at a second address in the second storage device, a second data transfer operation to transfer data stored at the second address in the second storage device to the first storage device.

14. The information processing system according to claim 11, wherein
the access of the predetermined pattern set by the controller comprises an access of a first predetermined pattern, which comprises wiring of first pattern data having the predetermined length and a first predetermined bit sequence, and
the controller is configured to perform, in response to a first command requesting the access of the first predetermined pattern at a first address in the second storage device, a first data transfer operation to transfer data stored at the first address in the second storage device to the first storage device.

15. The information processing system according to claim 11, wherein the controller is configured to, during the data transfer operation, overwrite the pattern data onto a part of the data stored at the address and save the overwritten part of the data in a temporary memory.

16. The information processing system according to claim 15, wherein the controller is configured to, during the data transfer operation, write the data stored at the address the part of which has been overwritten with the pattern data to a new address.

17. The information processing system according to claim 16, wherein the controller is configured to, during the data transfer operation, replace the pattern data at the new address with the saved overwritten part of the data.

18. The information processing system according to claim 11, wherein the controller is configured to receive the command in accordance with a first protocol for memory access.

19. The information processing system according to claim 18, wherein
the controller is configured to set the access of the predetermined pattern as the indication regarding the data transfer between the first storage device and the second storage device, in response to a setup command from the host, and
the controller is configured to receive the setup command in accordance with a second protocol for input/output, the second protocol having a greater protocol overhead than the first protocol.

20. The information processing system according to claim 19, wherein the first protocol is Compute Express Link (CXL).mem, and the second protocol is CXL.io.
